(19) United States
(12) Patent Application Publication
(10) Pub. No.: US 2016/0160779 A1
(43) Pub. Date: Jun. 9, 2016

(54) Prognostic Engine System and Method

(71) Applicant: CATERPILLAR INC., Peoria, IL (US)

(72) Inventors: Mary L. Yeager, Lafayette, IN (US); Francis L. Clark, Pekin, IL (US); Brandon Gregory, Peoria, IL (US)

(73) Assignee: CATERPILLAR INC., Peoria, IL (US)

(21) Appl. No.: 14/563,365

(22) Filed: Dec. 8, 2014

(51) Int. Cl. F02D 41/22; F02D 35/02; F02P 5/153; F02D 41/34

(52) U.S. Cl. CPC F02D 41/22; F02D 41/34; F02D 35/023; F02P 5/153

(57) ABSTRACT

An electronic controller for an engine is programmed to operate in a prognostic mode, in which a baseline record of combustion parameters is created and stored in non-volatile memory, and in a diagnostic mode, in which an operating set of combustion parameters is compiled. During operation, the electronic controller retrieves the baseline record and compares it with the operating set to determine, in real time during engine operation, whether an abnormal combustion is present in the cylinder. The electronic controller activates at least one failure flag when the abnormal combustion is determined to be present.

### TECHNICAL FIELD

This disclosure relates generally to internal combustion engines and, more particularly, to systems and methods for prognosis and diagnosis of in-cylinder engine combustion.

### BACKGROUND

Internal combustion engines have many components that can affect the reliable and efficient operation of the engine. Engine operation and performance may be especially affected by the condition of those components that are associated with the engine's combustion cylinders such as intake and exhaust valves, piston rings, head gaskets and the like. Failures can occur for various reasons, such as thermal cycling, fatigue and the like. When such components fail, or their performance is compromised by a less than complete failure, the effects of such failure may not be immediately apparent to the engine's operator. However, such failures may cause a reduction in engine power, loss of sufficient sealing of the engine's combustion cylinder, increased oil consumption, decreased fuel economy, and other effects.

Even in the absence of a component-related condition, in-cylinder engine combustion may be further affected by various environmental factors such as ambient air temperature, barometric pressure, fuel quality, engine core temperature, and other factors. Such environmental factors, in addition to or instead of engine component conditions, may result in issues with engine combustion including misfire, detonation of the fuel/air mixture, and/or pre-ignition. Apart from adversely affecting engine fuel consumption, noise, roughness, emissions, and power output, improper combustion can also result in premature engine component failure, engine starting issues, and others.

Modern engines may further include variable valve timing systems, which can actively and selectively control engine valve timing. The calibration of such systems and their performance degradation over time may also affect ignition timing and cause varying degrees of abnormal engine combustion, which can in turn affect engine performance and emissions. The detection and diagnosis of abnormal engine combustion is a time consuming task because it traditionally entails running the engine in a diagnostic or service mode with instrumentation added to the engine to detect abnormalities. Moreover, abnormal combustion that is imperceptible to the user may go undetected. In the past, various attempts have been made to diagnose such engine conditions during normal engine operation by use of accelerometers or other, secondary measurements, such as fluctuations in engine torque or power output, fluctuations in engine intake or exhaust pressure, and others, with mixed results.

One previously proposed solution for detecting and diagnosing abnormal engine combustion can be seen in JP2008208751A, which is entitled “Deterioration Degree Diagnostic System of Engine Component.” In this reference, the disclosed system detects cylinder pressure and calculates a time variation ratio of the compression pressure of the cylinder to determine whether abnormal compression in the cylinder is present. However, the system cannot detect other parameters relative to engine combustion.

### SUMMARY

In one aspect, the disclosure describes an engine. The engine has a cylinder that includes a cylinder bore and a piston reciprocally disposed within the cylinder bore, which is formed in a cylinder block. A crankshaft is connected to the piston such that reciprocal motion of the piston results in rotational motion of the crankshaft. One or more piston ring seals are connected to the piston and disposed between the piston and the cylinder bore to sealably and slidingly engage the cylinder bore. A cylinder head is disposed to block an open end of the cylinder bore to define a combustion chamber in the cylinder bore between the piston and the cylinder head. An intake valve is disposed to selectively open such that the combustion chamber is fluidly connected with an intake manifold, and an exhaust valve is disposed to selectively open such that the combustion chamber is fluidly connected with an exhaust collector.

In one embodiment, the engine includes a pressure sensor disposed to sense a cylinder pressure within the combustion chamber and provide a pressure signal, which is indicative of the cylinder pressure. The engine further includes an engine timing sensor disposed to sense an angle of a rotating component of the engine and provide an engine timing signal, which is indicative of a position of the piston within the cylinder bore. An electronic controller is programmed to receive the pressure signal and the engine timing signal. The electronic controller is further programmed to operate in a prognostic mode, in which a baseline record of combustion parameters is created and stored in non-volatile memory, and in a diagnostic mode, in which an operating set of combustion parameters is compiled. During operation, the electronic controller retrieves the baseline record of combustion parameters from the non-volatile memory, and compares the baseline record with the operating set of combustion parameters to determine, in real time, whether an abnormal combustion is present in the cylinder. The electronic controller is programmed to activate at least one failure flag when the abnormal combustion is determined to be present.

In another aspect, the disclosure describes a method for diagnosing abnormal combustion in a cylinder of an engine. The method includes monitoring a pressure signal from an engine pressure sensor, which is indicative of a fluid pressure within a combustion chamber of the engine, and monitoring an engine timing signal from an engine timing sensor, which is indicative of a rotation of an output shaft of the engine and also indicative of a position of a piston within the cylinder. The pressure signal from the engine pressure sensor and the engine timing signal from the engine timing sensor are received in the electronic controller, which analyzes the pressure and engine timing signals such that, in a prognostic mode of operation, the electronic controller determines a baseline set of combustion parameters and stores the baseline set of combustion parameters in non-volatile memory. In a diagnostic mode of operation, the electronic controller determines an operating set of combustion parameters, each of the operating set of combustion parameters corresponding to one of the baseline set of combustion parameters. During engine operation, the electronic controller is programmed to retrieve the baseline set of combustion parameters from the non-volatile memory, compare each of the operating set of combustion parameters with the corresponding one of the baseline set of parameters, and activate a failure flag when at least one of the operating set of combustion parameters differs by more than a corresponding threshold value form the corresponding one of the baseline set of parameters.

In yet another aspect, the disclosure describes a method for performing diagnostic testing in the operation of an engine. The method includes establishing one or more nominal operating conditions of the engine, acquiring a set of combustion parameters early in the service life of the engine while the engine operates at the one or more nominal operating conditions, saving the set of combustion parameters as a baseline record in a non-volatile memory device of an electronic controller associated with the engine, monitoring normal engine operation to detect a presence of the one or more nominal operating conditions, and, when the engine is operating at the one or more nominal operating conditions, acquiring a set of operating combustion parameters, which correspond to the baseline record, comparing the set of operating combustion parameters with the baseline record, and activating a fault flag when at least one of the operating combustion parameters differs from a corresponding baseline record.

### BRIEF DESCRIPTION OF THE DRAWINGS

FIG. 1 is a block diagram representation of an engine in accordance with the disclosure.

FIG. 2 is a detailed, enlarged view of a combustion cylinder of an engine, which is shown in cross section, in accordance with the disclosure.

FIG. 3 is a block diagram for a prognostic system in accordance with the disclosure.

FIG. 4 is qualitative graph showing a pressure trace within a combustion cylinder in accordance with the disclosure.

FIG. 5 is a block diagram for a diagnostic system in accordance with the disclosure.

FIG. 6 is a flowchart for a method for diagnosing abnormal combustion in an engine in accordance with the disclosure.

### DETAILED DESCRIPTION

This disclosure relates to internal combustion engines and, more particularly, to the prognosis of engine component performance and the later diagnosis of abnormal performance that may result in abnormal combustion in the engine on a continuous, real-time basis while the engine is operating in the field. The engine may be operating in mobile or stationary machines in land- or marine-based applications. The systems and methods for prognosing and, later, diagnosing the quality of combustion are applicable to any type of engine and are not limited to the embodiments described herein. Accordingly, the present disclosure draws on an exemplary compression ignition or diesel engine for purpose of illustration, but the general concepts underlying the illustrated prognosing and diagnostic systems and methods are applicable to spark-ignition gasoline engines, natural gas engines, compression-ignition engines, engines operating with two or more fuels, and the like. For example, the principles disclosed herein can be applied to gas engines that include a spark plug and an associated spark timing signal similar to a fuel injector timing signal on a diesel engine. The spark timing signal can be used in the same way as the diesel injector timing signal as described in the present disclosure. Moreover, the principles can be applied to other engine variants such as engines that include a prechamber that ignites a small portion of fuel and then injects the burning mixture into the larger engine cylinder, or a gas engine that premixes gas and air in the intake manifold and/or intake ports, and the like.

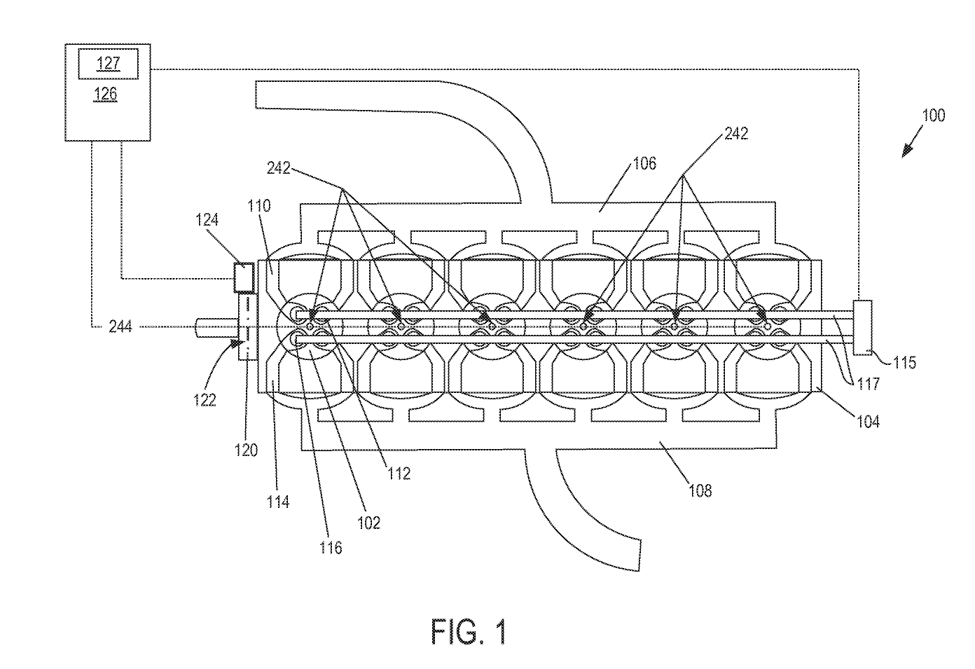

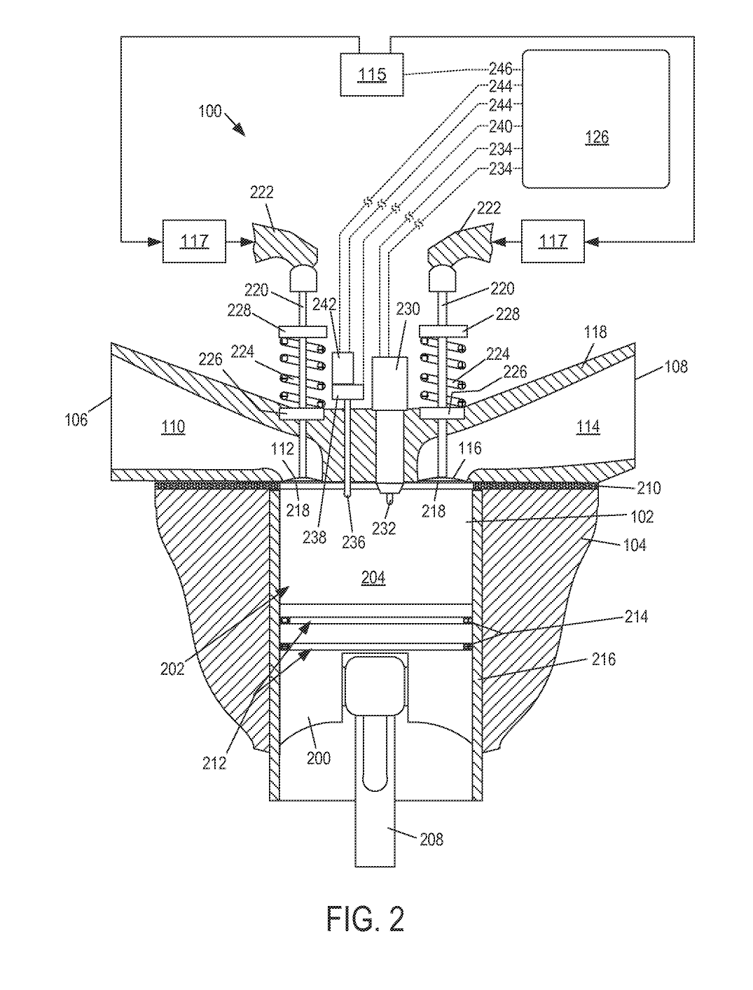

A block diagram of an engine 100 having a plurality of combustion cylinders 102 formed within a cylinder block 104 is shown in FIG. 1. A detailed, enlarged view of one of the plurality of combustion cylinders 102 of the engine 100 (FIG. 1) is shown in cross section in FIG. 2. In the two illustrations of FIGS. 1 and 2, same or similar elements and features are denoted by the same reference numerals for simplicity.

The engine 100 includes an intake manifold 106 and an exhaust collector 108 in fluid communication with the plurality of combustion cylinders 102. In the illustrated embodiment, the intake manifold 106 fluidly communicates with each of the plurality of combustion cylinders 102 via intake runners 110 that are fluidly connectable to respective cylinders from the plurality of combustion cylinders 102 when a corresponding one of intake valves 112 is open. Similarly, the exhaust collector 108 is connectable with cylinders from the plurality of combustion cylinders 102 via exhaust runners 114 through exhaust valves 116. Activation of the intake valves 112 and the exhaust valves 116 in the illustrated embodiment is accomplished by a variable valve activation system 115, which includes actuators 117 associated with the various valves. As shown in FIG. 2, the intake runners 110 and the exhaust runners 114 are at least partially formed within a cylinder head 118, but any one of a number of other known engine configurations may be used.

Each of the plurality of combustion cylinders 102 includes a piston 200 that is configured to reciprocate within a bore 202. The portion of the bore 202 between the piston 200 and the cylinder head 118 defines a combustion chamber 204 that is generally sealed when combustion of an air/fuel mixture occurs. Air for the air/fuel mixture, which may further include other fluids such as exhaust gas, and/or a gaseous fuel, is provided to the combustion chamber 204 generally through the intake runners 110. Fuel is provided to the combustion chamber from an injector 230, which in the illustrated embodiment is configured to directly inject fuel into the chamber. In different engines or in alternative embodiments, the injector or another fuel delivery valve may be located elsewhere in the engine such that fuel and air are premixed before being provided to the combustion chamber 204.

When in the combustion chamber 204, the air/fuel mixture is compressed as the piston 200 moves to reduce the volume of the combustion chamber 204 until combustion occurs. Following combustion, exhaust gas remaining in the combustion chamber 204 is evacuated into the exhaust collector 108 through one of the exhaust valves 116. The reciprocal motion of the piston 200 is transformed to rotary motion of a crankshaft 120 (FIG. 1). The crankshaft 120, which is typically connected to the piston 200 via a connecting rod 208 (FIG. 2), includes indicia or other features 122 that are detectable by a crankshaft position sensor 124 (FIG. 1) during operation. Information or signals from the crankshaft position sensor 124 are provided to an electronic controller 126, which includes non-volatile memory 127. The information on the angle of the crankshaft 120 can be directly correlated to the position of the piston 200 within the cylinder. The quality of the sealed containment of the air/fuel combustion mixture within the combustion chamber 204, various environmental factors, as well as fuel quality, fuel constituents and fuel composition (especially for gaseous fuels), and accuracy in the fuel delivery of the fuel system, among other factors, have been known to directly affect the efficiency and quality of engine operation, and especially the timing of compression ignition and the burn duration and intensity of the fuel burning in the combustion chamber 204 during engine operation.

In the illustrated embodiment, various engine components contribute to the various sealing functions provided to the combustion chamber 204 during operation. As is best shown in FIG. 2, a head gasket 210 is sealably positioned along the interface between the cylinder block 104 and the cylinder head 118 such that leakage of fluids is minimized along that interface. The piston 200 includes a plurality of piston ring grooves 212 (two shown) along its outer periphery. Each of the piston ring grooves 212 includes a piston ring seal 214 that radially, slidably, and generally sealably engages the inner wall of the bore 202. Although the bore 202 against which the piston ring seal 214 slides may be formed directly into the cylinder block 104, the engine 100 is shown in FIG. 2 to include a cylinder sleeve 216 within which the bore 202 is defined.

The intake valves 112 and the exhaust valves 116 are poppet-style valves forming seats that fluidly block the intake runners 110 and the exhaust runners 114, respectively, from the combustion chamber 204 when the intake valves 112 and the exhaust valves 116 are closed. Accordingly, each of the intake valves 112 and the exhaust valves 116 forms a poppet portion 218 that sealably engages a corresponding seat formed in the cylinder head 118. Each of the intake valves 112 and the exhaust valves 116 includes a stem portion 220 connected to the poppet portion 218. The stem portion 220 includes a ball and socket connection arrangement with a valve bridge 222 (partially shown). Rocking motion of the valve bridge 222 causes the opening and closing of the intake valves 112 and the exhaust valves 116, as is known. Activation of the valve bridge 222 is responsive to the selective motion of the actuators 117, which may directly activate each valve bridge 222 or may alternatively shift an activation phase of the bridge activation in response to the selective operation of the variable valve activation system 115, which is responsive to a valve timing signal 246. A spring 224 disposed between a guide 226 and a retainer 228 biases each of the intake valves 112 and each of the exhaust valves 116 towards a closed position. Although one configuration for the structure, installation and actuation of the intake valves 112 and the exhaust valves 116 is shown herein, any other appropriate configuration for selective or variable valve activation may be used.

In the illustrated embodiment, a fuel injector 206 includes a nozzle tip 232 disposed in fluid communication with the combustion chamber 204 and configured to selectively inject an amount of fuel into the combustion chamber 204 during operation. The fuel injected by the nozzle tip 232 mixes with air, a mixture of air with exhaust gas, and/or a mixture of air with a gaseous fuel that is present in the combustion chamber 204 to form a combustible mixture that is compressed before combustion in the known fashion. The injection of fuel from the injector 230 can be accomplished by providing an appropriate injection signal to the injector from the electronic controller 126 via injector communication conduits 234.

In the particular exemplary embodiment shown in FIG. 2, the engine 100 is a diesel engine. Accordingly, when operating or starting the engine under certain conditions, such as cold start conditions, a glow plug 236 can be disposed in fluid contact with the combustion chamber 204 to warm the air/fuel mixture in the combustion chamber 204 and thus aid in initiating burning of the combustible mixture. More specifically, the glow plug 236, which is an electrically operated heater, can provide thermal energy to the air/fuel mixture in the combustion chamber 204, thus reducing the flash point or ignition temperature of the mixture to aid in engine operation, especially under cold start engine operating conditions. The glow plug 236 as shown is connected to an actuator 238 that activates the device in response to a signal from the electronic controller 126 that is provided via a glow plug communication line 240.

In the illustrated embodiment, the presence and position of the glow plug 236 in direct contact with the combustion chamber 204 is exploited to provide an input indicative of the pressure of fluids within the combustion chamber 204. In this way, the glow plug 236 is slidably but sealably connected to the cylinder head 118 and communicates forces to a pressure sensor 242, which in the illustrated embodiment is connected on an external side of the glow plug 236. Alternatively, it is contemplated that the pressure sensor 242 may be directly connected to sense cylinder pressure without an intervening structure such as the glow plug as shown herein. In one embodiment, the pressure sensor 242 may use a combination of a piezoresistive element and a strain gage, which together provide signal indicative of cylinder pressure. The pressure sensor 242 may otherwise be constructed by any appropriate and known method, such as those including piezoelectric elements, optical devices, strain devices and others. Alternatively, the pressure sensor 242 may be connected in direct fluid communication with the combustion chamber 204.

Regardless of the type and positioning employed for the installation of the pressure sensor 242, a signal directly indicative of the pressure, in real time, of fluids within the combustion chamber 204 is provided to the electronic controller 126 via pressure signal communication lines 244. Certain sensor configurations, such as those sensors using piezoelectric elements, may be further configured to provide a signal indicative of vibration experienced by the sensor, for example, when intake or exhaust valves close, during engine operation.

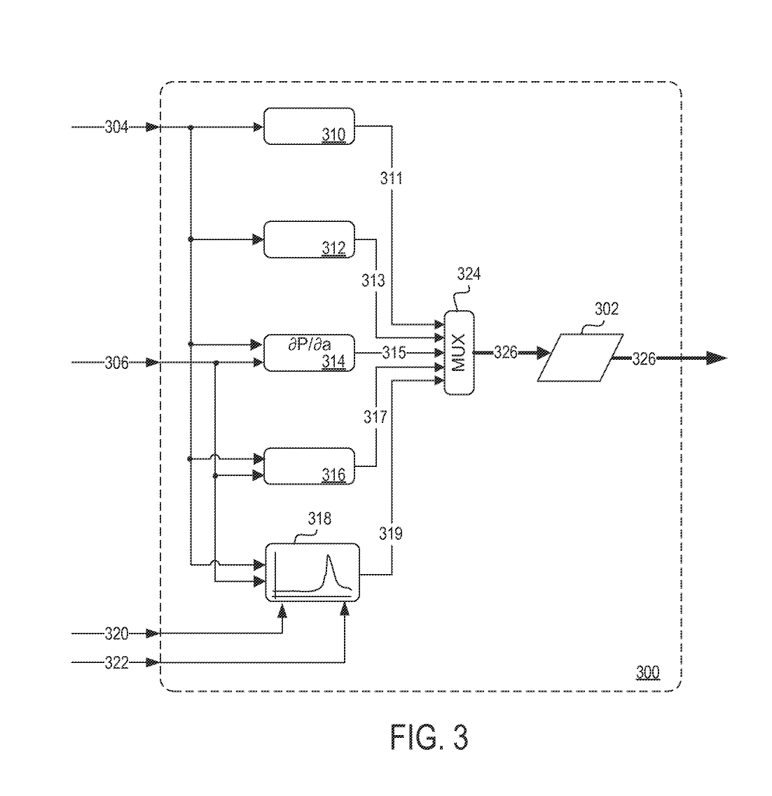

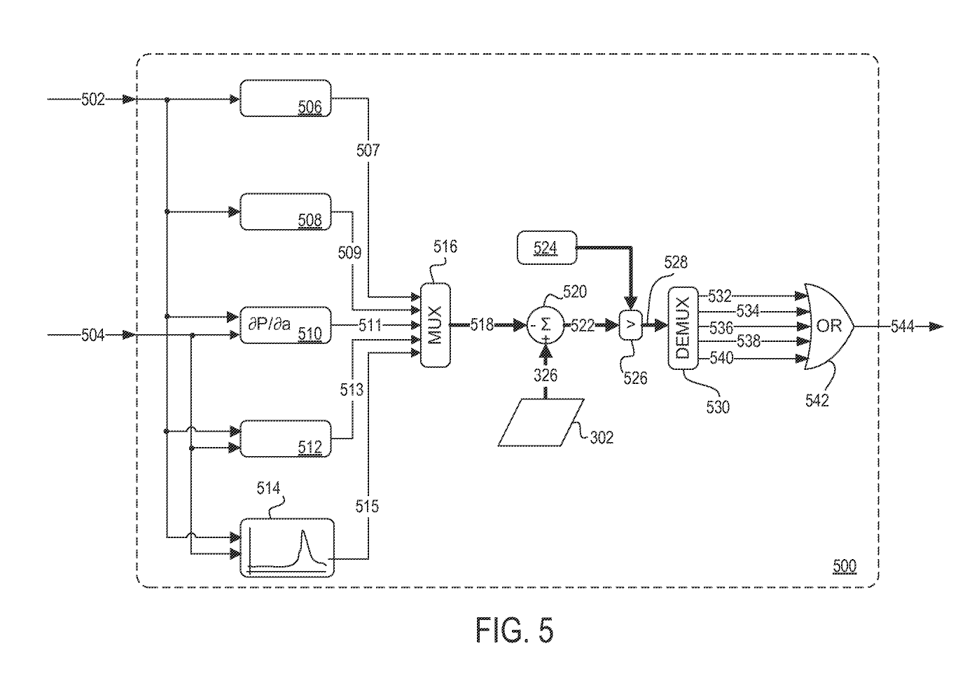

The electronic controller 126 may be a single controller or may include more than one controller disposed to control various functions and/or features of a machine. For example, a master controller, used to control the overall operation and function of a vehicle, machine or stationary application may be cooperatively implemented with an engine controller used to control the engine 100. In this embodiment, the term “controller” is meant to include one, two, or more controllers that may be associated with the engine 100 and that may cooperate in controlling various functions and operations. The functionality of the electronic controller, while shown conceptually in FIGS. 3 and 5 to include various discrete functions for illustrative purposes only, may be implemented in hardware and/or software without regard to the discrete functionality shown. Accordingly, various interfaces of the electronic controller are described relative to components of the engine in the block diagram of FIG. 1. Such interfaces are not intended to limit the type and number of components that are connected.

In the contemplated embodiments of the present disclosure, a baseline value for one or more combustion parameters is recorded during a hot test of the engine following a new or rebuilt engine assembly at a factory, or as early as possible after the engine enters into the field. Such baseline values can be recorded any suitable engine operating point, or engine speed and load combination, when the engine operates at a specific environment including ambient temperature, altitude (or barometric pressure), and engine coolant and/or oil temperature, which can be referred to as the nominal operating condition. It should be appreciated that more than one nominal operating condition may be selected. These baseline values, which are assumed to reflect normal, expected or nominal engine operation, are recorded and stored in non-volatile memory within an electronic controller, for example the non-volatile memory 127 of the electronic controller 126 (FIG. 1) associated with the engine. At specified time intervals, for example, each time the engine reaches the nominal operating condition, or one of the nominal operating conditions, the same operating parameters are automatically recorded and compared to the respective baseline values that were recorded at the outset. When it is determined that the historical (baseline) values and measured values differ by more than a specified diagnostic threshold, for example, 5% or another value, the control shall report a combustion problem that will notify an operator of the need for engine operation diagnosis and/or repair of engine components. In the event a combustion problem is detected, the engine may first attempt to mitigate the issue, for example, by disabling gas or diesel fuelling in engines equipped with dual fuels, changing diesel injector and/or spark plug timing angles, changing gas and/or diesel injection quantities, and the like, before a fault is declared, in case the fault is rectified, or after the fault is declared, to indicate the need for engine service.

In the present disclosure, separate controls are described that perform the prognosis of engine operation, which includes the initial recording of the baseline combustion system operation, and the diagnosis of engine operation, which includes recording measured values and comparing the measured values to the baseline values at periodic intervals during operation. Accordingly, a block diagram for a prognostic control 300 configured to prognose operation of the combustion cylinders of the engine by recording one or more baseline sets of parameters early during the service life of an engine, as described above, is shown in FIG. 3.

The prognostic control 300 is configured to monitor engine combustion during the nominal operating condition(s) and record a baseline set of values in a non-volatile data store 302. The prognostic control 300 receives various inputs and provides various outputs during operation, and may be operating within the electronic controller 126 as shown in FIG. 1. Relevant to the present disclosure, certain inputs and outputs are discussed, but additional and/or different inputs and outputs than those discussed may be used. In the illustrated embodiment, a cylinder pressure signal 304 indicative of the cylinder pressure, measured directly and in real time during engine operation at a nominal operating condition from within the cylinder is provided to the prognostic control 300. As previously discussed, for example, relative to engine 100 (FIG. 1), more than one cylinder in the plurality of combustion cylinders 102 may be present. Although a single, cylinder pressure signal 304 is shown in FIG. 3, it is contemplated that more than one input may be present when an engine includes more than one cylinder having instrumentation for monitoring pressure as generally described herein.

The prognostic control 300 may further receive an engine timing signal 306 that is indicative of the rotational orientation or angle of the engine crankshaft in real time. In the illustrated embodiment, the engine timing signal 306, which may be expressed in degrees of crankshaft or camshaft rotation, is in time-aligned relation to the cylinder pressure signal 304 such that a pressure and angle provided to the prognostic control 300 are provided concurrently and represent the then-present conditions in the cylinder being monitored. In the illustrated embodiment, the engine timing signal 306 may be provided by the crankshaft position sensor 124 (FIG. 1) that is associated with the engine crankshaft, or another sensor that is similarly associated with another rotating engine component such as a camshaft, which can provide signals indicative of the angular position of the engine's crankshaft or a derivative thereof, in real time during engine operation. It is noted that the engine timing signal 306 may be operating regardless of whether the engine is operating to produce power or whether the engine is motored, for example, by use of a starter motor, when the engine is decelerating without fuel being provided to the engine's cylinders or, in accordance with one embodiment, when fuel is selectively cut off to the cylinder during a deceleration or engine-braking operation. The operating conditions of the engine, in general, depends on the selection of the one or more nominal operating conditions.

The cylinder pressure signal 304 and engine timing signal 306 are provided and processed in various sub-modules of the prognostic control 300 to determine various combustion characteristics and attributes, in real time. In the embodiment shown, various determinations of the operation of the engine in terms of combustion are discussed, but it should be appreciated that additional or fewer parameters may be included depending on the particular engine or engine application that is considered. In the illustrated embodiment, the cylinder pressure signal 304 is provided to a detonation determinator 310. The detonation determinator 310 includes a comparator function that compares the pressure signal with a pressure band that comprises a lower cylinder pressurization threshold pressure and an upper pressure value. When the cylinder pressure signal 304 indicates that a cylinder is pressurized, i.e., when the lower pressurization threshold pressure has been reached, a determination is made whether the pressure continues to rise and surpasses the upper pressure value, which is indicative of a burning of the fuel/air mixture in the cylinder, has been achieved. When the cylinder is pressurized and burning of fuel has occurred, the detonation determinator records the cylinder pressure values over time and, optionally, averages the corresponding cylinder values for a predetermined number of detonations in the cylinder, for example, one hundred detonations, and provides a detonation record 311. Instead of or in addition to the pressure measurements, the detonation determinator may also determine an amplitude and frequency of detonation pressure waves that are detected within the cylinder.

The prognostic control 300 further includes a peak pressure determinator 312. The peak pressure determinator 312 may be a monitoring function that records and analyzes the cylinder pressure signal 304 to discern the peak pressure achieved during fuel burning in the cylinder. Similar to the detonation determinator 310, the peak pressure determinator 312 may monitor and analyze the cylinder pressure signal 304 when the engine operates at the nominal operating condition(s) to provide a peak cylinder pressure record 313, which can be indicative of a single combustion event in the cylinder or may alternatively represent an average of the peak pressures of a predetermined number of combustion events.

The cylinder pressure signal 304, along with the engine timing signal 306, are further provided to a pressure rise determinator 314. Pressure rise within the cylinder can be used to infer the rate of burning of the fuel provided to the cylinder. In the illustrated embodiment, the pressure rise determinator 314 may operate to calculate a parameter related to the derivative of an increase in the cylinder pressure signal 304 with respect to crank angle or time, as indicated by the engine timing signal 306, in the form of ∂P/∂α, where P indicates cylinder pressure and α indicates angle of crank rotation or time. Any suitable algorithm may be used to calculate this derivative, including a difference calculation of the ratio between a difference in pressure rise over a difference in engine crank angle. The pressure rise determinator 314 thus determines a pressure rise record, which can be based on a single combustion or be averaged over numerous combustions, which the pressure rise determinator 314 provides as a pressure rise record 315.

The prognostic control 300 further includes a combustion initiation determinator 316, which receives at least the cylinder pressure signal 304 and the engine timing signal 306. The combustion initiation determinator 316 continuously compares the cylinder pressure with the then-present timing to determine a sharp rise in cylinder pressure, which is indicative of a burn initiation or ignition of the fuel within the cylinder. When ignition is detected, the combustion initiation determinator 316 selects the crank angle corresponding to the ignition detected and provides an actual ignition record 317, which essentially includes the engine timing value at which ignition occurred. As in the other modules, the actual ignition record 317 may represent a single ignition event or be the average of multiple such events.

The prognostic control 300 further includes a cylinder pressure trace recorder 318 which determines and provides a baseline pressure trace record 319. The cylinder pressure trace recorder 318 receives the cylinder pressure signal 304 and the engine timing signal 306 in time aligned relation, as described above. Optionally, the cylinder pressure trace recorder 318 further receives an engine speed signal 320 and an engine load signal 322, which are indicative, respectively, of the then-present engine speed and commanded or actual engine load. As can be appreciated, the engine speed signal 320 and the engine load signal 322 should be within a predetermined range of the corresponding engine speed and load conditions of the nominal operating condition. During operation in a calibration or baseline determination mode, the cylinder pressure trace recorder 318 may record the cylinder pressure vs. crank angle for at least a range of crankshaft angles corresponding to the compression and combustion strokes of a particular cylinder. Alternatively, the entire pressure trace over two or more full crankshaft rotations may be recorded. The pressure trace information is analyzed and provided as the baseline pressure trace record 319.

The detonation record 311, peak cylinder pressure record 313, pressure rise record 315, actual ignition record 317, and baseline pressure trace record 319 are provided to an aggregator or multiplexer 324 and are aggregated into a baseline engine combustion record 326. Although various parameters are shown here, the baseline engine combustion record 326 may include fewer or more parameters. Examples of additional parameters that may be included with the baseline engine combustion record 326 include engine speed, engine load, engine temperature as indicated by engine coolant and/or engine oil, fuel temperature, fuel pressure, ambient air temperature, barometric pressure, engine run hours, use of exhaust gas recirculation (EGR), engine on-time, and other parameters. The baseline engine combustion record 326 is provided to and stored within the non-volatile data store 302 to serve as the prognostic information, which the engine controller will use during operation for diagnosing abnormal combustion in the cylinder. From the data store, the baseline information is made available to the engine controller during engine operation such that combustion system operation diagnosis can be carried out whenever the engine happens to work in one of the nominal operating conditions. The baseline engine combustion record 326 may be provided to other control modules operating within the electronic controller as will be described hereinafter.

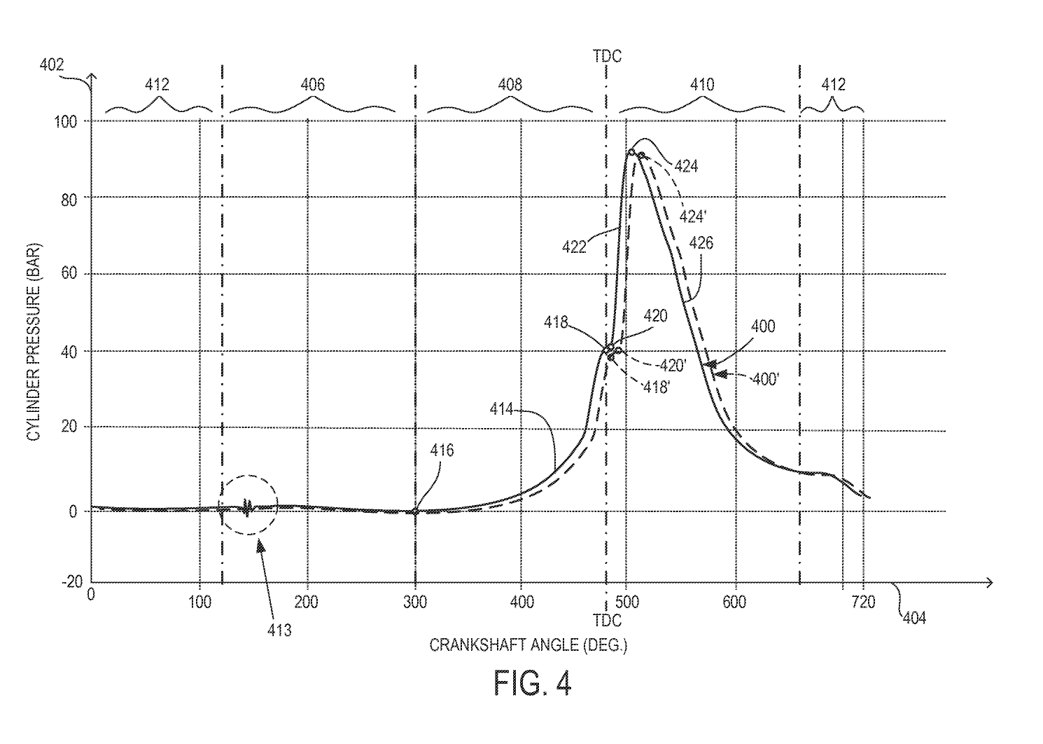

Before describing the engine controls performing the diagnosis of engine operation, it may be useful to illustrate some exemplary parameters that are tracked on a representative and exemplary cylinder pressure trace. A sample cylinder pressure trace 400 is shown in FIG. 4. The sample cylinder pressure trace 400, shown in solid line, is a plot of a pressure 402 within an engine cylinder, which is arranged on the vertical axis, with respect to crankshaft angle 404, which is arranged along the horizontal axis. In a four-stroke engine, such as the engine 100 (FIG. 1), a complete cylinder cycle spans over two complete crankshaft revolutions, which is represented in FIG. 4 by 720 degrees of crankshaft rotation. In these two revolutions, four strokes are represented that include an intake stroke 406, a compression stroke 408, a combustion stroke 410, and an exhaust stroke 412. The compression stroke 408, which may span less than 180 degrees of crankshaft rotation depending on the timing for opening and closing the intake and/or exhaust valves, generally involves closing the combustion chamber to trap at least fuel and air therein, and moving the piston deeper into the bore to compress the fuel/air mixture until ignition. Fuel may be provided late in the compression stroke 408 and may further be provided in more than one injection events such as one or more pre-pilot injections, a pilot injection, a main injection, and one or more post-injections. It is noted that fuel may also be supplied after ignition of the original fuel has begun.

In the sample cylinder pressure trace 400, a pressure increase due to the compression of the fluids within the cylinder is represented by segment 414, which begins at a compression initiation point 416 and increases up to a pressure 418 representing a piston position close to the top dead center (TDC) position, i.e., the maximum depth displacement of the piston within the cylinder. This pressure increase is due to the mechanical compression of the fluids within the engine cylinder.

Ignition of the fluids within the cylinder occurs or is carried out close to or at the TDC position, and is represented on the sample cylinder pressure trace 400 by ignition point 420. Following ignition point 420, there is a substantial pressure increase in the combustion chamber represented by segment 422, which extends from the ignition point 420 up to a peak cylinder pressure 424. This pressure increase is due to the rapid expansion of the burning material within the engine cylinder. Although the burning material within the cylinder is expanding, the piston is also pushed downwards as it carries out the combustion stroke 410. After sufficient expansion of the burning material within the increasing cylinder volume, cylinder pressure begins to drop over segment 426, which may also extend into the exhaust stroke 412. The presence of an abnormal combustion condition would be apparent from the cylinder pressure trace during operation. For example, a misfire would not produce the pressure increase due to combustion over the appropriate segment. Similarly, a detonation or knocking, as it is sometimes referred, would produce a rough portion in the pressure trace that is indicative of pressure waves present within the combustion chamber. Late ignition would produce a shifted trace, and so on.

With reference to the above discussion, the sample cylinder pressure trace 400 can represent the pressure trace record and the various other parameter records acquired by prognostic control 300. In the chart of FIG. 4, a pressure trace 400′ is also shown, which can represent a pressure trace acquired during engine operation that is subsequent to the acquisition of the baseline records. As shown, the measured, pressure trace 400′ is shifted relative to the sample cylinder pressure trace 400 to show a change in engine performance of time, the effects of which are the subject of the diagnosis of engine combustion using baseline engine performance as a basis for comparison. Accordingly, for the same initiation of compression initiation point 416, a lower mechanical compression pressure 418′ than the pressure 418 may be measured, and a later ignition 420′ than the ignition point 420 may be detected. Similarly, a lower peak pressure 424′ as compared to the peak cylinder pressure 424 may be detected. These and other aging, component wear, or environmental effects can be diagnosed by the engine controller by reference to the baseline parameters.

In general, parameters such as peak cylinder pressure, maximum pressure rise in the cylinder, detonation timing, crankshaft angle at the start of combustion, crankshaft angle at the center of combustion, and other parameters, can be observed or calculated directly for each cylinder and from each cylinder's pressure measurement in at least one or more software loops during engine operation at one or more nominal operating conditions. In a control software, such information can be processed such that the measured or observed values for various combustion parameters are compared to the baseline values for those parameters. At times when the measured or observed parameters differ from the corresponding baseline values by more than a predetermined diagnostic threshold difference, the system can report and record a combustion problem, which can be used to withdraw the engine from service and/or address any issues present on the engine when the engine is undergoing scheduled maintenance. When diagnosing the presence of abnormal combustion conditions, the engine control software can mitigate any abnormal conditions while the engine is operating and without requiring the engine to be removed from service. For example, in one embodiment, if pre-ignition is observed, which includes the detection of ignition that is earlier than a commanded fuel injection or spark timing, the engine operation may be adjusted to change the fuel injection or spark timing according to the period of pre-ignition that was observed in an effort to rectify the situation without intruding on the operator's use of the engine.

Apart from the pressure of the operating fluids within the combustion chamber, the pressure sensors used in certain engines can also be useful in detecting the opening and closing events of the various valves associated with each combustion chamber, for example, intake valves and exhaust valves. In one embodiment, vibrations caused by the closing of an intake or exhaust valve, as each valve contacts its respective valve seat under force from a closing spring or a closing actuator, can be detected by the cylinder pressure sensor, for example, a piezoelectric sensor, as a vibration. An exemplary wave or vibration that may be sensed by the pressure sensor is illustrated as vibration 413 in FIG. 4. In one contemplated embodiment, the frequency, amplitude and time of occurrence of the vibration 413 in terms of crankshaft angle can be monitored in addition to the various engine combustion parameters to determine the timing for opening and closing of the intake and exhaust valves, which is especially useful in engines having variable valve timing control for all cylinders together or for each cylinder separately. By monitoring the cylinder pressure signal with sufficient resolution, in one embodiment, the frequency and amplitude of the valve closing event can be used to calculate valve closing force, which is indicative of valve lash, and other mechanical aspects of valve operation. These parameters can also be compared with predetermined thresholds to determine whether a variable valve opening and closing system is operating properly.

A block diagram for a diagnostic control 500, which is configured to monitor engine combustion and diagnose abnormal combustion conditions based on prognostic information acquired earlier in the life of the engine, is shown in FIG. 5. The diagnostic control 500 is configured to receive various inputs and provide various outputs during operation, and may be operating within the electronic controller 126 as shown in FIG. 1. Relevant to the present disclosure, certain inputs and outputs are discussed, but additional and/or different inputs and outputs than those discussed may be used. In the illustrated embodiment, a cylinder pressure signal 502 indicative of the cylinder pressure when the engine is operating normally and at one of the nominal operating conditions is measured directly and in real time and provided to the diagnostic control 500. As previously discussed, for example, relative to engine 100 (FIG. 1), more than one cylinder in the plurality of combustion cylinders 102 may be present. Although a single, cylinder pressure signal 502 is shown in FIG. 5, it is contemplated that more than one input may be present when an engine includes more than one cylinder having instrumentation for monitoring pressure as generally described herein.

The diagnostic control 500 may further receive an engine timing signal 504 that is indicative of the rotational orientation or angle of the engine crankshaft in real time. The engine timing signal 504, and also the engine timing signal provided to the prognostic control 300, may be actually provided by sensors associated with the engine crankshaft, camshaft, flywheel, another rotating engine component, or a combination of more than one signals indicative of the rotation of one or more of these or other rotating components associated with the engine. In the illustrated embodiment, the engine timing signal 504, which may be expressed in degrees of crankshaft or camshaft rotation, is in time-aligned relation to the cylinder pressure signal 502 such that a pressure and angle provided to the diagnostic control 500 are provided concurrently and represent the then-present conditions in the cylinder being monitored while the engine is operating at one of the nominal operating conditions. In the illustrated embodiment, the engine timing signal 504 may be provided by the crankshaft position sensor 124 (FIG. 1) that is associated with the engine crankshaft, or another sensor that is similarly associated with another rotating engine component such as a camshaft, which can provide signals indicative of the angular position of the engine's crankshaft or a derivative thereof, in real time during engine operation. It is noted that the engine timing signal 504 may be operating regardless of whether the engine is operating to produce power or whether the engine is motored, for example, by use of a starter motor, when the engine is decelerating without fuel being provided to the engine's cylinders or, in accordance with one embodiment, when fuel is selectively cut off to the cylinder during a deceleration or engine-braking operation, if one of the nominal operating conditions requires this type of operation.

The cylinder pressure signal 502 and engine timing signal 504 are provided and processed in various sub-modules of the diagnostic control 500 to determine various combustion characteristics and attributes, in real time. In the embodiment shown, various determinations of the operation of the engine in terms of combustion are discussed, but it should be appreciated that additional or fewer parameters may be included depending on the particular engine or engine application that is considered. In the illustrated embodiment, the cylinder pressure signal 502 is provided to a detonation determinator 506. The detonation determinator 506, similar to the detonation determinator 310 (FIG. 3), compares the pressure signal with a pressure band that comprises a lower cylinder pressurization threshold pressure and an upper pressure value to determine whether detonation has occurred, and/or determines the amplitude and/or frequency of pressure waves within the cylinder, and provides a detonation signal 507. The detonation determinator may further include a transform, model function, or other algorithm that can determine the amplitude and/or frequency of pressure fluctuations within the combustion chamber, and compare those parameters with respective threshold values.

The diagnostic control 500 further various other determinator functions that determine signals corresponding to the various baseline engine parameters recorded by the prognostic control 300, as discussed above relative to FIG. 3. Accordingly, the diagnostic control 500 includes a peak pressure determinator 508, which provides a peak pressure signal 509, a pressure rise determinator 510, which provides a pressure rise signal 511, a combustion initiation determinator 512, which provides a combustion indication signal in the form of the pressure trace 513, and a cylinder pressure trace recorder 514, which provides a pressure trace 513.

The diagnostic control 500 thus determines of estimates the various combustion parameters discussed, which are aggregated or multiplexed at a multiplexer 516 to form an operating engine combustion record 518. The operating engine combustion record 518 is compared to the baseline engine combustion record 326 (also see FIG. 3), for example, at a summing junction 520, where each of the parameters included in the operating engine combustion record 518 is compared with the corresponding combustion parameter in the baseline engine combustion record 326 to yield a set of corresponding differences 522 between the various parameters. Although the summing junction 520 is shown as a subtractor function here, any other known method for comparing parameters can be used. For example, the summing junction may include an addition function, other mathematical functions, filtering, debouncing, averaging, and the like.

Each of the set of differences 522 is compared with a corresponding threshold limit 524 at a comparator 526 to determine if a fault 528 is present. The comparator, which is generically shown to include a “greater than” notation, may include any other mathematical comparison function, and may alternatively include other types and/or combinations of logic and mathematical functions configured to infer or determine the presence of the fault. The fault 528 is provided to a de-multiplexer 530 to yield specific faults that may be present. The specific faults may include a misfire 532, which corresponds to the detonation signal 507, a loss of cylinder pressure 534, which corresponds to the peak pressure signal 509, and an abnormal burn rate 536, which corresponds to the pressure rise signal 511. Depending on the parameters that were acquired or otherwise determined at the prognostic and diagnostic stages, other faults may also be determined corresponding to such other parameters. An overall combustion system fault 540, which corresponds to the pressure trace 515, may also be provided if the pressure trace 515 differs significantly from the baseline pressure trace record 319, which might indicate a component failure in the engine such as in the valve activation system or in one of the components participating in sealing the combustion chamber. As can be appreciated, the overall combustion system fault 540 would likely appear in conjunction with one or more of the remaining faults discussed, but would serve as an indication of the severity of the fault such that engine service would be indicated to the operator.

Each of the faults provided at the de-multiplexer 530 is provided to an OR gate 542 such that the presence of at least one fault will activate a fault flag 544. The fault flag 544 may be used to alert the machine operator of a fault, for example, by illuminating a lamp or a message alerting the operator of a fault, and/or may additionally be used to automatically mitigate the fault by changing engine operation, to the extent feasible, to address the fault condition. Apart from the various combustion parameters discussed herein, other combustion parameters may also be used. For example, the controller can determine the ignition mean effective pressure (IMEP), the maximum heat release rate of the fuel burn, and other parameters.

### INDUSTRIAL APPLICABILITY

The present disclosure is applicable to internal combustion engines of any type and for any application. In the illustrated embodiments, the engine described is shown as having a pressure sensor associated with each engine cylinder. In alternative embodiments, depending on the type of abnormal combustion being diagnosed and/or addressed, pressure sensors can be used in one or, at least, in fewer than all engine cylinders. For example, for an engine having uniform performance in the various cylinders, if an abnormal combustion condition that may be caused by factors that are not specific to the engine hardware present in the cylinder monitored, then a single pressure sensor may be installed in a representative engine cylinder for monitoring of all engine cylinders. Alternatively, more than one pressure sensor may be used in the same engine cylinder.

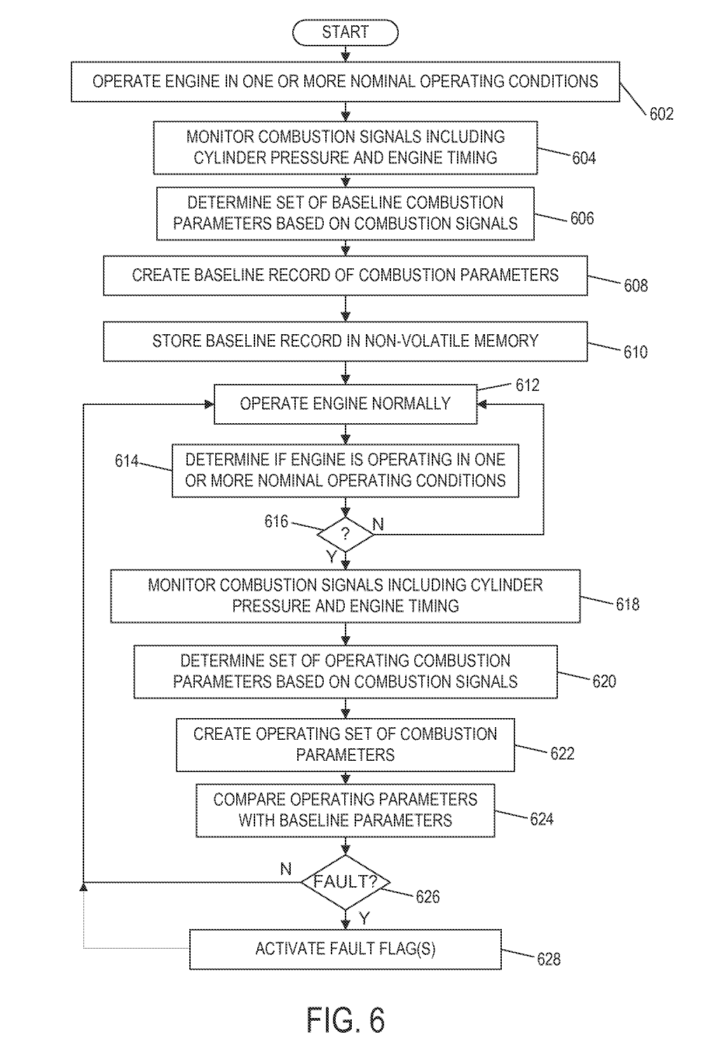

The systems and methods described herein are applicable for various engine prognostic and diagnostic tests, which are performed when the engine is new and then later during normal operation of the engine. A flowchart for a method of prognosing combustion system parameters for an engine, and then diagnosing the condition of various abnormal engine operating conditions based on the prognostic information is shown in FIG. 6. At the outset, the method includes operating the engine during at one or more nominal operating condition(s) at 602. In one embodiment, the nominal operating condition may be a full load condition of the engine, which is carried out at an engine manufacturing plant for a new engine during a so-called engine hot test. As is known, engine hot testing is a test that can be carried out on newly assembled engines in a test cell. Alternatively, the nominal operating condition may be run during a similar hot test conducted for a newly rebuilt or reconditioned engine on a test cell or in a vehicle. In general, engine operation at the nominal operating condition should be run as close as possible to the early operation of an engine having new or different components surrounding or associated with the combustion cylinder(s) of the engine, including a new or different engine electronic controller, to provide a true baseline combustion condition of the engine with which operation later in the life of the engine can be compared. The type of engine components, whose replacement or reconditioning may require operation in a prognostic mode to acquire a new baseline set of parameters includes the piston, fuel injector, cylinder pressure sensor, intake or exhaust valves, piston ring seals, cylinder head gasket, and/or other engine components that affect cylinder operation either directly or indirectly, which may be replaced or reconditioned. This early operation of the engine at the one or more nominal operating conditions is considered as engine operation in a prognostic mode.

While the engine operates at the nominal operating condition, sensor and other signals associated with the combustion system, including, specifically, cylinder pressure and engine timing, are monitored at 604 with an electronic controller associated with, controlling and monitoring the operation of the engine. Based on these signals, including, specifically, cylinder pressure and engine timing, the electronic controller determines a set of baseline combustion parameters at 606, and creates a computer record of the baseline combustion parameters at 608. The baseline record of combustion parameters is stored in non-volatile memory of the electronic controller at 610 for later use during the life of the engine, and the engine then completes its prognostic operating mode and enters into a normal engine operating period at 612.

While the engine operates normally at 612, the electronic controller monitors engine operation to determine whether the engine happens to operate at the nominal operating condition, while the engine otherwise operates normally in the field, at 614. When the engine has been determined to operate at the nominal operating condition, as indicated by the various signals monitored by the electronic controller including engine speed and engine load, the electronic controller makes a determination to enter into a diagnostic operating mode at 616. The diagnostic operating mode is activated when an otherwise normally operating engine operates at the nominal operating condition, for example, at rated power, continuously and for at least a predetermined period. If engine operation does not remain at the nominal operating condition for the predetermined period, or if one of the combustion parameters of the engine, for example, oil or coolant temperature, altitude, air temperature, and others, are not within predefined ranges, then the electronic controller avoids entering the diagnostic mode at 616 and continues normal engine operation at 612. When all relevant parameters are determined to be within the nominal operating condition ranges, an engine diagnosis is undertaken, which diagnosis is intended to be imperceptible to the engine operator.

While a diagnosis is underway, the electronic controller begins monitoring combustion signals at 618. The signals monitored are the same or similar type of signals monitored in the prognostic mode at 604. Based on the diagnostic determination at 618, the electronic controller determines a set of operating combustion parameters of the engine at 620, which mirror the baseline combustion parameters determined at 606. An operating set of combustion parameters is created at 622, and is compared to the baseline parameters at 624. When it is determined that the operating parameters are within a predetermined range of the baseline parameters, engine operation returns to normal at 612. However, when at least one of the operating parameters is outside an acceptable range of the baseline parameters at the determination 626, a corresponding fault flag is activated at 628.

In one optional embodiment, depending on the type of condition that is diagnosed, the electronic controller may allow the engine to operate but at a reduced power output mode such that further damage to engine components may be avoided while the engine is scheduled for service or repair. Additional examples of mitigation measures include disabling gas or diesel fuelling in engines equipped with dual fuels, changing diesel injector and/or spark plug timing angles, changing gas and/or diesel injection quantities, and others. In another optional embodiment, an intrusive test during which the fuel provided to one or more cylinders is cut off during engine operation may be carried out. In such embodiment, fuel would continue to be supplied as normal to other cylinders while the particular cylinder cycling without fuel is motored. In this way, the motoring pressure can be monitored at different conditions. As a refinement to this embodiment, the engine may be run at a specific more than one operating condition, for example, a service test, such that cylinder operation can be examined under different operating conditions in a troubleshooting or maintenance environment.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. An engine, comprising:
a cylinder including a cylinder bore formed in a cylinder block;
a piston reciprocally disposed within the cylinder bore;
a crankshaft connected to the piston such that reciprocal motion of the piston results in rotational motion of the crankshaft;
one or more piston ring seals connected to the piston and disposed between the piston and the cylinder bore to sealably and slidingly engage the cylinder bore; and
a cylinder head disposed to block an open end of the cylinder bore such that a combustion chamber is defined within the cylinder bore between the piston and the cylinder head;
a pressure sensor disposed to sense a cylinder pressure within the combustion chamber and provide a pressure signal, which is indicative of the cylinder pressure;
an engine timing sensor disposed to sense an angle of a rotating component of the engine and provide an engine timing signal, which is indicative of a position of the piston within the cylinder bore; and
an electronic controller programmed disposed to receive the pressure signal and the engine timing signal;
wherein the electronic controller is programmed to operate in a prognostic mode, in which a baseline record that includes combustion parameters is created and stored in non-volatile memory, and in a diagnostic mode, in which an operating set of combustion parameters is compiled;
wherein the electronic controller is further programmed to retrieve the baseline record from the non-volatile memory, and compare the baseline record with the operating set of combustion parameters to determine, in real time during engine operation, whether an abnormal combustion is present in the cylinder; and
wherein the electronic controller is configured to activate at least one failure flag when the abnormal combustion is determined to be present.

2. The engine of claim 1, wherein a prognostic mode of operation is executed at least once, early in a service life of the engine, and at any time during a life of the engine when various engine components including pistons, injectors, the cylinder pressure sensor, are replaced or reconditioned.

3. The engine of claim 1, wherein the diagnostic mode is executed numerous times during normal engine operation when a particular set of engine operating parameters, including engine speed and engine load, are within predetermined ranges.

4. The engine of claim 1, wherein the baseline record includes at least one of a detonation record, a peak pressure record, a pressure rise record, an actual ignition record, and a cylinder pressure trace record.

5. The engine of claim 1, wherein the operating set of combustion parameters includes at least one of a detonation signal, a peak pressure signal, a pressure rise rate signal, an actual ignition signal, and a pressure trace signal.

6. The engine of claim 5, wherein the at least one failure flag is indicative of at least one of a misfire, which corresponds to the detonation signal, a loss of cylinder pressure, which corresponds to the peak pressure signal, an abnormal burn rate, which corresponds to the pressure rise rate signal, and a pre-ignition, which corresponds to the actual ignition signal.

7. The engine of claim 1, wherein the electronic controller is programmed to compare the baseline record with the operating set of combustion parameters by calculating a difference between each respective parameter of the baseline record and the operating set of combustion parameters to yield a corresponding difference, wherein the corresponding difference is compared with a corresponding threshold value from a set of threshold values stored in the non-volatile memory.

8. The engine of claim 7, wherein the at least one failure flag is activated when the corresponding difference exceeds the corresponding threshold value.

9. The engine of claim 1, further comprising a plurality of cylinders, each of the plurality of cylinders including a corresponding pressure sensor such that the electronic controller receives and analyzes a plurality of pressure signals, wherein the electronic controller is further configured to activate a corresponding at least one fault flag with respect to each of the plurality of cylinders separately during normal engine operation.

10. A method for diagnosing abnormal combustion in a cylinder of an engine, comprising:
monitoring a pressure signal from an engine pressure sensor, which is indicative of a fluid pressure within a combustion chamber of the engine;
monitoring an engine timing signal from an engine timing sensor, which is indicative of a rotation of an output shaft of the engine and also indicative of a position of a piston within the cylinder;
receiving the pressure signal from the engine pressure sensor and the engine timing signal from the engine timing sensor in an electronic controller;
analyzing the pressure signal and the engine timing signal using the electronic controller, such that:
in a prognostic mode of operation, the electronic controller determines a baseline set, which includes combustion parameters, and stores the baseline set in non-volatile memory,
in a diagnostic mode of operation, the electronic controller determines an operating set of combustion parameters, each of the operating set of combustion parameters corresponding to one of the baseline set;
wherein the electronic controller is programmed to:
retrieve the baseline set from the non-volatile memory,
compare each of the operating set of combustion parameters with the corresponding one of the baseline set, and
activate at least one failure flag when at least one of the operating set of combustion parameters is different by more than a corresponding threshold value form the corresponding one of the baseline set.

11. The method of claim 10, wherein the prognostic mode of operation is executed once, early in a service life of the engine.

12. The method of claim 10, wherein a diagnostic mode is executed numerous times during normal engine operation when a particular set of engine operating parameters, including engine speed and engine load, are within predetermined ranges.

13. The method of claim 10, wherein the baseline set includes at least one of a detonation record, a peak pressure record, a pressure rise record, an actual ignition record, and a cylinder pressure trace record.

14. The method of claim 10, wherein the operating set of combustion parameters includes at least one of a detonation signal, a peak pressure signal, a pressure rise rate signal, an actual ignition signal, and a pressure trace signal.

15. The method of claim 14, wherein the at least one failure flag is indicative of at least one of a misfire, which corresponds to the detonation signal, a loss of cylinder pressure, which corresponds to the peak pressure signal, an abnormal burn rate, which corresponds to the pressure rise rate signal, and a pre-ignition, which corresponds to the actual ignition signal.

16. The method of claim 10, wherein the electronic controller is programmed to compare the baseline set with the operating set of combustion parameters by calculating a difference between each respective parameter of the baseline set and the operating set of combustion parameters to yield a corresponding difference, wherein the corresponding difference is compared with a corresponding threshold value from a set of threshold values stored in the non-volatile memory.

17. The method of claim 16, wherein the at least one failure flag is activated when the corresponding difference exceeds the corresponding threshold value.

18. The method of claim 10, wherein the engine further comprises a plurality of cylinders, each of the plurality of cylinders including a corresponding pressure sensor such that the electronic controller receives and analyzes a plurality of pressure signals, wherein the electronic controller is further configured to activate a corresponding at least one fault flag with respect to each of the plurality of cylinders separately during normal engine operation.

19. A method for performing diagnostic testing in an operation of an engine, comprising:
establishing a one or more nominal operating conditions of the engine;
acquiring a set of combustion parameters, early in a service life of the engine, while the engine operates at the one or more nominal operating conditions;
saving the set of combustion parameters, early in the service life of the engine, as a baseline record in a non-volatile memory device of an electronic controller associated with the engine;
monitoring normal engine operation to detect a presence of the one or more nominal operating conditions, and
when the engine is operating at the one or more nominal operating conditions,
acquiring a set of operating combustion parameters, which correspond to the baseline record,
comparing the set of operating combustion parameters with the baseline record, and
activating at least one failure flag when at least one of the set of operating combustion parameters is different from a corresponding baseline record.

20. The method of claim 19, wherein the baseline record includes at least one of a detonation record, a peak pressure record, a pressure rise record, an actual ignition record, and a cylinder pressure trace record, wherein an operating set of combustion parameters includes at least one of a detonation signal, a peak pressure signal, a pressure rise rate signal, an actual ignition signal, and a pressure trace signal, and wherein the at least one failure flag is indicative of at least one of a misfire, which corresponds to the detonation signal, a loss of cylinder pressure, which corresponds to the peak pressure signal, an abnormal burn rate, which corresponds to the pressure rise rate signal, and a pre-ignition, which corresponds to the actual ignition signal.
